(19) United States
(12) Patent Application Publication
(10) Pub. No.: US 2026/0116562 A1
(43) Pub. Date: Apr. 30, 2026

(54) METHOD FOR ASSISTING THE PILOTING OF A ROTARY WING AIRCRAFT IN A FUEL-ECONOMY MODE

(71) Applicant: SAFRAN HELICOPTER ENGINES, Bordes (FR)

(72) Inventors: Quentin VINCENZOTTO, Moissy-Cramayel (FR); Alexandre Edouard Emile FIGIELSKI, Moissy-Cramayel (FR); Sébastien Alexis Matthieu CARLES, Moissy-Cramayel (FR)

(73) Assignee: SAFRAN HELICOPTER ENGINES, Bordes (FR)

(21) Appl. No.: 19/151,923

(22) PCT Filed: Feb. 1, 2024
(86) PCT No.: PCT/FR2024/050132

§ 371 Date: Jul. 29, 2025

(30) Foreign Application Priority Data
Feb. 1, 2023 (FR) FR2300936

(51) Int. Cl. B64D 31/00; B64C 27/04; B64D 43/00; B64D 45/00; B64U 20/80; B64U 50/10

(52) U.S. Cl. CPC B64D 31/00; B64C 27/04; B64D 43/00; B64D 45/00; B64U 20/80; B64U 50/10; B64D 2045/0085

(57) ABSTRACT

A method for assisting the piloting of a rotary-wing aircraft, the aircraft including at least two engines, a first engine being able to be put in standby to ensure the operation of a second engine in fuel economy mode, the so-called ECO mode, a method in which, to achieve a determined number of flight hours between two overhauls by limiting the wear of the second engine in ECO mode, an engine control temperature associated with the second engine is computed in a flight computer as a function of a maximum power predefined in ECO mode of the second engine, the engine control temperature being representative of a current state of damage of the second engine and displayed on a flight screen for the attention of a pilot of the aircraft, so as to allow him to remain below the engine control temperature.

### TECHNICAL FIELD

This invention relates to the field of control of rotary-wing aircraft, particularly helicopters or drones, and more specifically refers to a fuel economy mode or “ECO mode” consisting in putting one of the two engines of a twin-engine aircraft in standby mode during cruise, holding flight, or surveillance and/or search phases (loitering) in order to save fuel.

### PRIOR ART

Climate change is a major preoccupation for many legislative and regulatory bodies throughout the world. Specifically, various restrictions on carbon emissions have been, are being or will be adopted by various States. In particular, an ambitious standard is applicable to both new types of airplane and also to those currently in circulation, requiring the implementation of technological solutions to render them compliant with the regulations in effect. In recent years civil aviation has been committed to making a contribution to the combat against climate change.

Technological research has already enabled a very significant improvement in the environmental performance of airplanes. The Applicant takes into consideration the factors affecting all the phases of design and development to obtain components and aeronautical products which consume less energy, are more environmentally-friendly and can be integrated and used in civil aviation with only moderate environmental impacts, in the aim of improving the energy efficiency of airplanes. As a consequence, the Applicant is constantly working to reduce its climate impact by the use of methods and the exploitation of development and manufacturing processes which are virtuous and keep greenhouse gas emissions to a minimum to reduce the environmental footprint of its activity.

This sustained research and development effort simultaneously concerns the new generations of airplane engines, the lightening of aircraft, particularly via the materials used and lighter onboard equipment, the development of the use of electrical technology to provide propulsion, and finally aeronautical biofuels.

In this context, it is known for twin-engine aircraft to resort to using the engines in fuel economy mode, the so-called ECO mode, whether it be done with the combustion chamber of the engine on or off, during cruise or holding flight or surveillance and/or search phases (loitering). In such a mode, used for example in rotary-wing twin-engine aircraft, one of the engines of the aircraft is put in standby mode.

However, when incorrectly used, this operating mode can cause premature wear to the engine supplying the propulsion power of the aircraft, particularly for the hot parts of the gas turbine, a phenomenon known as endocreep.

However, this wear of the engines has a direct effect on the number of flight hours between two overhauls (TBO or Time Between Overhauls) indicated by the engine manufacturer.

### SUMMARY OF THE INVENTION

This invention thus has as subject a method for informing the pilot about the state of damage of the aircraft engines so that he can maintain, at all times, the objective of the number of flight hours (or TBO) claimed by the engine manufacturer.

These aims are achieved by a method for assisting the piloting of a rotary-wing aircraft, the aircraft including at least two engines, a first engine being able to be put in standby to ensure the operation of a second engine in fuel economy mode, the so-called ECO mode, the method for assisting the piloting being characterized in that, to achieve a determined number of flight hours between two overhauls by limiting the wear of the second engine in ECO mode, an engine control temperature (TC_PME) associated with the second engine is computed in a flight computer as a function of a maximum power (PME) predefined in ECO mode of said second engine, the engine control temperature (TC_PME) being representative of a current state of damage of the second engine and displayed on a flight screen for the attention of a pilot of the aircraft, so as to allow him to remain below said engine control temperature (TC_PME).

Thus, if in ECO mode, the pilot keeps the temperature of the engine below this engine control temperature (TC_PME), he will achieve the average time between two overhauls (TBO) claimed by the engine manufacturer.

Preferably, the engine control temperature (TC_PME) is determined based on values of the creep counters of the two engines and on a number of flight hours carried out since the last overhaul.

Advantageously, the value of the creep counters, associated with an engine ageing model, takes into account both the state of damage of the engine when all the engines are active and the state of damage of the engine when they are in standby mode.

Preferably, the engine control temperature is a maximum temperature or an average temperature.

According to the embodiment envisioned, the engine control temperature is determined for a mission representative of the missions carried out by the aircraft and including at least one phase of activation of ECO mode and it is further determined based on a value of the cycle counters of the engines. It can also take into account an alternation of the engines operating in ECO mode.

Advantageously, the engine control temperature is displayed on a flight screen incorporated into a first limit indicator of the aircraft.

The method according to the invention can be applied to a multi-engine helicopter or a multi-engine drone as well as to a single-or multi-engine aircraft in which the engine control temperature is used outside of ECO mode to preserve the life of the engine.

The invention further relates to a rotary-wing aircraft comprising a flight computer and a flight screen, each configured to implement the method for assisting piloting as defined above.

### BRIEF DESCRIPTION OF THE DRAWINGS

Other features and advantages of this invention will become apparent from the description given below, with reference to the appended drawings which illustrate an exemplary embodiment thereof without any limitation and wherein:

FIG. 1 shows an example of a mission profile of a rotary-wing aircraft, and

FIG. 2 illustrates the different steps of the method for determining the engine control temperature in ECO mode, according to an example of the invention.

### DESCRIPTION OF THE EMBODIMENTS

The invention proposes to create a new rating associated with ECO mode: the so-called PME (Maximum Power in ECO mode). This rating is not a limit, i.e. the power is not saturated, but an item of information that will be communicated to the aircraft pilot to help him contain the damage to the engines of this aircraft. It is therefore a question of taking into account the actual use of the engine and updating in real time the item of information communicated to the pilot by way of a flight control indicator available in the cockpit, for example on the first limit indicator known as the FLI.

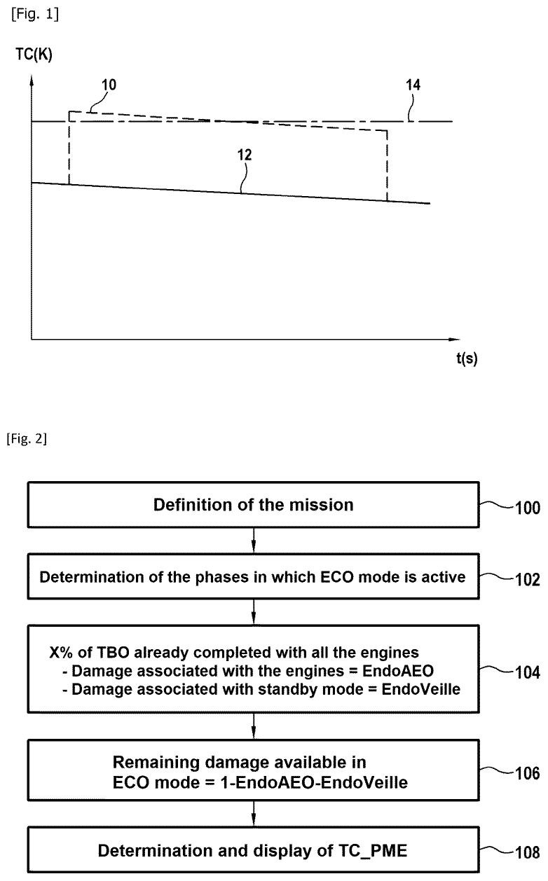

FIG. 1 shows an example of a partial mission profile implementing this ECO mode. On the abscissa is the duration of the mission segment in question, and on the ordinate the engine control temperature (TC) representative of the engine power. This mission includes different phases, but the only one illustrated is the mission segment in which a phase in ECO mode is triggered during a cruise phase 12. In this ECO mode, the temperature illustrated in dotted lines 10 is the maximum recommended temperature (or power) of the active engine, the other engine being in standby. The temperature in dot-and-dash lines 14 corresponds to the associated average temperature (or power). The engine control temperature (TC_PME) corresponds, for example, to said temperature in dot-and-dash lines 14.

As can be seen on FIG. 1, this maximum temperature and this average temperature are both greater than the power (or temperature) required in the cruise phase 12 carried out with all the engines supplying power (=conventional operation, so-called AEO for All Engines Operating), without of course being able to exceed the maximum take-off power (PMD).

FIG. 2 shows the steps of the method of the invention allowing the determination of the TC_PME.

It begins, in a first step 100, with the definition of a mission corresponding to the average of the missions previously carried out by the aircraft (standard mission) and more generally representative of the missions of the aircraft (for example including a combination mission). Alternatively or complementarily, a provisional standard mission or combination mission can be considered.

The seasonality of aircraft sorties is preferably taken into account. A more specific mission defined at the request of the pilot (according, for example, to a predefined trajectory and a particular load) can also be taken into account.

In a following step 102, one determines the phases of this mission in which the ECO mode is active (cruise, or surveillance/search/hold phase (loitering) etc.).

In a following step 104, a reading is taken from the flight computer of the percentage of the number of flight hours already carried out since the previous overhaul of the engines as well as the state of the creep counters (two for each engine), one associated with the damage (current wear) to the engine when it is supplying power, and the other with the damage to the engine when it is in standby. One predicted damage for the AEO phases and another for the standby phases are determined, preferably using the results of the step 102 and using a gas turbine ageing model. The aforementioned counter of damage to the engine when it is supplying power (AEO mode) is added to the projection of ageing of the gas turbine in AEO mode to provide a parameter EndoAEO. In the same way, a parameter EndoVeille is computed based on the current wear of the engine in the standby phase and the projection of ageing of the gas turbine in standby mode (ECO mode).

In a following step 106, one computes a percentage (100% corresponding to a new engine) of the remaining damage available in ECO mode by subtracting the two abovementioned damage values EndoAEO and Endo Veille.

In a final step 108, the TC_PME is determined using the remaining damage available in ECO mode and displayed on the cockpit of the aircraft on a flight screen, typically on its FLI (First Limit Indicator).

The invention thus allows pilot guidance specific to the use of ECO mode by proposing to update the TC_PME throughout the engine life, as a function of data possessed by the flight computer, namely the state of the creep (and/or cycle) meters and the number of flight hours since the last overhaul (TBO considered as a level 3 maintenance operation).

Thus, for example assuming a TBO of 5000 flight hours for a given engine, if the pilot over-uses his engine, the TC_PME displayed on the dial bearing this indicator will decrease with the flight hours, asking him to adapt his missions to maintain this TBO of 5000FH.

It will however be noted that this indicator, indicating a maximum power to be observed to achieve the TBO claimed by the engine manufacturer, can also be applied outside of ECO mode, particularly on a single-engine helicopter. For example, a pilot often flying at a high power will prematurely wear out the engines and the TBO will not be reached.

It will also be noted that maintenance operations and particularly the alternation of the active engine during ECO mode (which preferably is not always the same but, on the contrary, can be one or the other of the two engines interchangeably) may be taken into account to determine the TC_PME. Specifically, use of the ECO mode can cause asymmetric wear to the engines and it appears useful to seek to render the progress of the creep and cycle counters more symmetrical by exchanging the engines, for example every 1000 flight hours during the corresponding maintenance (the engine active during the first time slot being that put in standby in the next slot, and so on for the following time slots).

Furthermore, if reference has mainly been made to conventional applications for twin-engine helicopters, the invention naturally has an application to multiple engines, as in the area of drones where a recommendation for use of each of the engines can thus also be made to the pilot.

1. A method for assisting the piloting of a rotary-wing aircraft, the aircraft including at least two engines, a first engine being able to be put in standby to ensure the operation of a second engine in fuel economy mode, the so-called ECO mode,
the method for assisting the piloting being characterized in that, to achieve a determined number of flight hours between two overhauls by limiting the wear of the second engine in ECO mode, an engine control temperature associated with the second engine is computed in a flight computer as a function of a maximum power predefined in ECO mode of said second engine, the engine control temperature being representative of a current state of damage of the second engine and displayed on a flight screen for the attention of a pilot of the aircraft, so as to allow him to remain below said engine control temperature.

2. The method as claimed in claim 1, wherein the engine control temperature is determined based on values of the creep counters of the two engines and on a number of flight hours carried out since the last overhaul.

3. The method as claimed in claim 2, wherein the value of the creep counters, associated with an engine ageing model, takes into account both the state of damage of the engine when all the engines are active and the state of damage of the engine when they are in standby mode.

4. The method as claimed in claim 1, wherein the engine control temperature is a maximum temperature or an average temperature.

5. The method as claimed in claim 1, wherein the engine control temperature is determined for a mission representative of the missions carried out by the aircraft and including at least one phase of activation of ECO mode.

6. The method as claimed in claim 1, wherein the engine control temperature is further determined based on a value of the cycle counters of the engines.

7. The method as claimed in claim 1, wherein the engine control temperature takes into account an alternation of the engines operating in ECO mode.

8. The method as claimed in claim 1, applied to a multi-engine helicopter or a multi-engine drone.

9. The method as claimed in claim 1, wherein the flight screen, on which the engine control temperature is displayed, is incorporated into a first limit indicator of the aircraft.

10. A rotary-wing aircraft comprising a flight computer and a flight screen, each configured to implement the method for assisting piloting as claimed in claim 1.
